(19) United States
(12) Patent Application Publication
(10) Pub. No.: US 2026/0112057 A1
(43) Pub. Date: Apr. 23, 2026

(54) Method of Determining the Position of an Object in a 3D Volume

(71) Applicant: VitVio Ltd, London (GB)

(72) Inventors: Peter Rennert, London (GB); Konstanty Kowalewski, London (GB); Grzegorz Jacenków, London (GB)

(73) Assignee: VitVio Ltd, London (GB)

(21) Appl. No.: 19/344,989

(22) Filed: Sep. 30, 2025

(30) Foreign Application Priority Data
Sep. 30, 2024 (GB) 2414339.8

(51) Int. Cl. G06T 7/73; G06T 15/08; G06T 19/20; G06V 10/25; G06V 10/764; G06V 10/774; G06V 20/64

(52) U.S. Cl. CPC G06T 7/75; G06T 15/08; G06T 19/20; G06V 10/25; G06V 10/764; G06V 10/774; G06V 20/64; G06T 2200/04; G06T 2207/20081; G06T 2219/2004

(57) ABSTRACT

A computer implemented method of determining the position of an object in a 3D volume comprising receiving a plurality of captured 2D or 3D spatial representations; segmenting or voxelizing the 2D or 3D spatial representations; assigning a first prediction score to each segment or voxel of each 2D spatial representation or 3D spatial representation; generating an array representative of the 3D volume comprised of a plurality of array voxels; associating each segment of each 2D spatial representation and each voxel of each 3D spatial representation with a plurality of the array voxels; assigning a first voxel score to each array voxel wherein each first voxel score is based on the first prediction score associated with each segment or voxel associated with the respective array voxel; and using a classification algorithm to classify an object within the 3D volume based on the first voxel scores.

### FIELD

The present disclosure relates to a computer implemented method of determining the position of an object in a 3D volume, a computer implemented method of generating synthetic data, a computer implemented method of training an ML algorithm and a computer program product comprising computer program code.

### BACKGROUND

Using computer vision to identify and track objects in a 3D volume is a challenging problem with a wide range of potential applications. Computer vision can be implemented in environments where the tracking of objects may allow for significant efficiencies to be implemented, such as in operating rooms where the tracking of the progress of an operation may allow for an understanding of the progress of the operation and also for analysing how an operation has been handled and how it may be improved in the future. Algorithms used for identifying and tracking objects can be computationally intensive and so finding ways to reduce the computational burden is desirable. Further, in order to train ML algorithms for computer vision, large quantities of data are required. Providing a method which allows for improved training of an ML algorithm by way of the generation of synthetic data and using that data for training are also advantageous in improving the object position identification and tracking.

### SUMMARY

According to a first aspect of the present disclosure, there is provided a computer implemented method of determining the position of an object in a 3D volume comprising:
a) receiving a plurality of captured spatial representations wherein each spatial representation comprises a representation of contents of the 3D volume and wherein each spatial representation is captured from a position with a point of view of the 3D volume wherein each spatial representation is one of a 2D spatial representation and a 3D spatial representation;
b) for each 2D spatial representation, defining a plurality of segments of the 2D representation wherein each segment defines an area of the 2D representation;
c) for each 3D spatial representation, defining a plurality of representation voxels of the 3D spatial representation wherein each representation voxel defines a sub-volume of the 3D volume;
d) assigning a first prediction score to each segment of each 2D spatial representation and assigning a first prediction score to each representation voxel of each 3D spatial representation wherein each first prediction score is indicative of a confidence that the segment or representation voxel comprises a first object;
e) generating an array representative of the 3D volume wherein the array defines a plurality of array voxels wherein each array voxel is representative of a different sub-volume of the 3D volume;
f) associating each segment of each 2D spatial representation with a plurality of the array voxels within the array based on the point of view from which the respective 2D spatial representation was captured, wherein the array voxels associated with each segment are those which are representative of positions of the segment at potential depths through the 3D volume at which the contents in the 2D spatial representation may be positioned;
g) associating each representation voxel of each 3D spatial representation with at least one array voxel based on the point of view from which the respective 3D spatial representation was captured;
h) assigning a first voxel score to each array voxel wherein each first voxel score is based on the first prediction score associated with each segment associated with the respective array voxel and each first prediction score associated with each representation voxel associated with the respective array voxel;
i) using a classification algorithm to classify an object within the 3D volume based on the first voxel scores.

In one or more embodiments, the method may comprise the steps of:
i) determining a region of interest based on the first voxel scores, wherein the region of interest is a region of the 3D volume that is represented by one or more array voxels;
j) receiving a focussed plurality of spatial representations, wherein the focussed plurality of spatial representations comprises spatial representations that comprise the region of interest;
k) for each 2D spatial representation of the focussed plurality of spatial representations defining a plurality of ROI segments of the 2D representation wherein each ROI segment defines an area of the region of interest;
l) for each 3D spatial representation of the focussed plurality of spatial representations, defining a plurality of ROI representation voxels of the 3D spatial representation wherein each ROI representation voxel defines a sub-volume of the region of interest;
m) assigning a first focussed prediction score to each ROI segment of each 2D spatial representation of the focussed plurality of spatial representations and assigning a first focussed prediction score to each ROI representation voxel of each 3D spatial representation wherein the first focussed prediction score is indicative of a confidence that the ROI segment or ROI representation voxel comprises the first object;
n) generating an ROI array representative of the region of interest of the 3D volume wherein the ROI array comprises a plurality of ROI array voxels wherein each ROI array voxel is representative of a different sub-volume of the region of interest;
o) associating each ROI segment of each 2D spatial representation of the focussed plurality of spatial representations with a plurality of ROI voxels within the ROI array based on the point of view from which the respective 2D spatial representation was captured, wherein the ROI array voxels associated with each ROI segment are those which are representative of positions of the ROI segment at potential depths through the 3D volume at which the contents in the 2D spatial representation may be positioned;
p) associating each ROI representation voxel of each 3D spatial representation of the focussed plurality of spatial representations with at least one ROI array voxel based on the point of view from which the respective 3D spatial representation was captured;
q) assigning a first focussed voxel score to each ROI array voxel wherein each first focussed voxel score is based on the first focussed prediction score associated with each ROI segment associated with the respective ROI array voxel and each first focussed prediction score associated with each ROI representation voxel associated with the respective ROI array voxel; and
r) wherein step i) of using a classification algorithm to classify an object within the 3D volume is further based on the first focussed voxel scores.

In one or more embodiments, the first voxel score may be a feature vector.

In one or more embodiments, the first focussed voxel score may be a feature vector.

In one or more embodiments, the method may further comprise:
assigning a second prediction score to each segment of each 2D spatial representation and assigning a second prediction score to each representation voxel of each 3D spatial representation wherein each second prediction score is indicative of a confidence that the segment or representation voxel comprises a second object;
assigning a second voxel score to each array voxel wherein each second voxel score is based on the second prediction score associated with each segment associated with the respective array voxel and each second prediction score associated with each representation voxel associated with the respective array voxel; and
   using the classification algorithm to classify a second object within the 3D volume based on the second voxel scores.

In one or more embodiments, each feature vector may comprise one or both of:
a plurality of voxel scores comprising at least the first voxel score and the second voxel score wherein each voxel score is indicative of an aggregate confidence value of a classification of the presence of an object being present within the segments and representation voxels associated with the array voxel with which the feature vector is associated; and
a plurality of focussed voxel scores comprising at least the first focussed voxel score and a second focussed voxel score, wherein each focussed voxel score is indicative of an aggregate confidence value of a classification of the presence of an object being present within the ROI segments and ROI representation voxels associated with the ROI array voxel with which the feature vector is associated.

In one or more embodiments, the method may further comprise using a classification algorithm to classify a second object within the 3D volume based on one or more feature vectors of the array voxels or the ROI array voxels.

In one or more embodiments, the method may include the steps of:
determining, by way of predetermined interrelation information, whether the first object is interrelated with the second object and, if the first object is interrelated with the second object,
recording the interrelation between the first object and the second object.

In one or more embodiments, determining whether the first object is associated with the second object may be based on a comparison of the interrelation information with one or both of:
a distance between the first object and the second object;
an angle between the first object and the second object
an overlap between a 3D bounding box of the first object and a 3D bounding box of the second object;
an overlap between a 2D bounding box of the first object and a 2D bounding box of the second object;
a difference between received velocity information about the first object and received velocity information about the second object;
a difference between received acceleration information about the first object and received velocity information about the second object; and
the classification of the first object and the classification of the second object.

In one or more embodiments, for each spatial representation of the plurality of spatial representations, the method may further comprise receiving a plurality of additional spatial representations captured from the same points of view as their corresponding initial spatial representations at different points in time and wherein the method further comprises tracking the changes in position of the first object based on the determination of the position of the first object within the 3D volume.

In one or more embodiments, the interrelation between the first object and the second may be determined to be a physical interrelation such that movement of the first object and the second object are spatially linked such that the second object can only move relative to the first object under predetermined constraints.

In one or more embodiments, tracking the position of the first and second objects in each of the additional spatial representations may further be based on the predetermined constraints.

In one or more embodiments, the predetermined constraints may define one or more of:
a fixed distance between the first object and the second object; and
a fixed range of rotational movement of the second object about the first object.

In one or more embodiments, at least two of the plurality of spatial representations may be captured by different spatial representation capture devices.

In one or more embodiments, the different types of sensors may be selected from a list comprising: an image camera; a lidar sensor; a radar sensor; a wifi sensing system; an IR sensor.

In one or more embodiments, the method may further comprise:
receiving data indicative a fictional object;
associating the fictional object with an array voxel by updating the feature vector of the voxel to incorporate the data indicative of the fictional object.

In one or more embodiments, the method may further comprise:
removing or adjusting data from one or more feature vectors associated with the presence of the first object such that the first object is removed from or adjusted within the 3D volume represented by the array.

According to a second aspect of the present disclosure, there is provided a computer implemented method of generating synthetic data representative of a 3D volume comprising:
receiving an array representative of the 3D volume wherein the array defines a plurality of array voxels wherein each array voxel is representative of a different sub-volume of the 3D volume and wherein each array voxel is associated with a feature vector indicative of the presence of one or more objects within the sub-volume represented by the array voxel; and one or more of:
receiving data indicative of a fictional object and associating the fictional object with an array voxel by updating the feature vector of the voxel to incorporate the data indicative of the fictional object;
removing or adjusting data from one or more feature vectors associated with the presence of the first object such that the first object is removed from or adjusted within the 3D volume represented by the array; and
moving data associated with an object within the 3D volume from a first feature vector to a second feature vector wherein the second feature vector is different to the first feature vector.

In one or more embodiments, received data indicative of a fictional object may be based on data indicative of a real object within the array.

In one or more embodiments, the method may further comprise generating a 2D spatial representation based on the generated synthetic data by:
selecting a point of view from which the 2D spatial representation should originate;
projecting the feature vectors of the array into a 2D spatial representation based on the selected point of view.

According to a third aspect of the present disclosure, a computer implemented method of training an ML algorithm comprising:
receiving synthetic data generated according to the method of the second aspect; and
training the ML algorithm using the generated synthetic data.

According to a fourth aspect of the present disclosure, a computer program product comprising computer program code configured such that, when executed on a processor, the computer program code is configured to cause a processor to carry out a computer implemented method according to any preceding aspect.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

The above discussion is not intended to represent every example embodiment or every implementation within the scope of the current or future Claim sets. The figures and Detailed Description that follow also exemplify various example embodiments. Various example embodiments may be more completely understood in consideration of the following Detailed Description in connection with the accompanying Drawings.

### BRIEF DESCRIPTION OF THE DRAWINGS

One or more embodiments will now be described by way of example only with reference to the accompanying drawings in which:

FIG. 1 shows an example method of determining the position of an object according to the present disclosure;

FIG. 2 shows an illustrative 3D volume comprising objects for tracking;

FIG. 3 shows a segmented 2D spatial representation of the 3D volume of FIG. 2 taken from a first point of view;

FIG. 4 shows a voxelized 3D spatial representation of the 3D volume of FIG. 2; FIG. 5 shows an example array comprised of a plurality of array voxels;

FIG. 6 shows an example array representative of a 3D volume and highlights the potential sub-volumes in which an object may be located when viewed from a first point of view and captured by a 2D spatial representation capture device;

FIG. 7 shows an example of how specific body parts and objects may be associated with voxels and, from this, how a human pose estimation can be obtained;

FIG. 8 shows a sequence of time-spaced representation of a 3D volume and how the objects within the 3D volume may move to different positions over time;

FIG. 9 shows a representation of how a synthetic representation of a 3D volume may be generated based on a real 3D volume;

FIG. 10 shows an example method of how to generate synthetic data according to the present disclosure;

FIG. 11 shows an example method of how to train an ML algorithm based on generated synthetic data; and

FIG. 12 shows an example computer program product comprising computer program code.

### DETAILED DESCRIPTION

A first aspect of the present disclosure is directed towards a computer implemented method of determining the position of an object within a 3D volume. The 3D volume is a volume of real space which may contain one or more objects, the positions of which may be desirable to identify. Once the position of an object has been identified in a 3D volume, it may also be of interest to continue to determine the object's position over time, i.e., to track the position of said object over time.

The present disclosure will provide examples of the application of object identification and tracking within a 3D volume in the context of a medical operating room. It will be appreciated, however, that the methods disclosed herein can be equally applied to many different types of 3D volume. The examples provided herein are provided for the sake of visualisation of the method as opposed to being intended to limit the scope of protection except unless explicitly stated otherwise. To provide additional examples, the 3D volume may alternatively be a hospitality environment, professional kitchen, factory, workshop, biological and chemical laboratory, another space within a hospital or any other place in which the tracking of objects is of interest. In particular, appropriate use cases may be those which a) people are not far from the cameras; and b) knowing what people do is useful and inexpensive.

According to an example of the present disclosure, a 3D volume in which objects are located may be an operating room. The 3D volume may also be a sub-volume of an operating room, if only a particular volume is of interest for object tracking. The objects within the 3D volume may be inanimate objects but may also be animate objects such as people or parts of people. For example, objects which may be of interest for identification, localisation and tracking may include: scalpels; tongs; gloves; other operating equipment; chairs; stools; beds; drawers or other inanimate objects. Examples of animate objects in an operating room may include: surgeons, nurses, or patients; hands; elbows; knees; or other body parts of a person including those which may be being operated on.

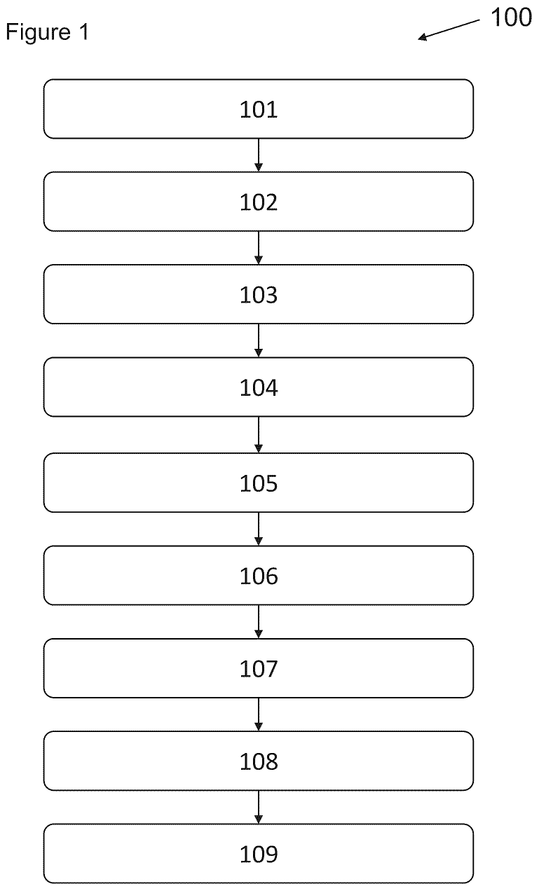

FIG. 1 shows an example computer implemented method 100 of determining the position of an object in a 3D volume according to the present disclosure. The method 100 comprises a plurality of steps which will be outlined hereinbelow.

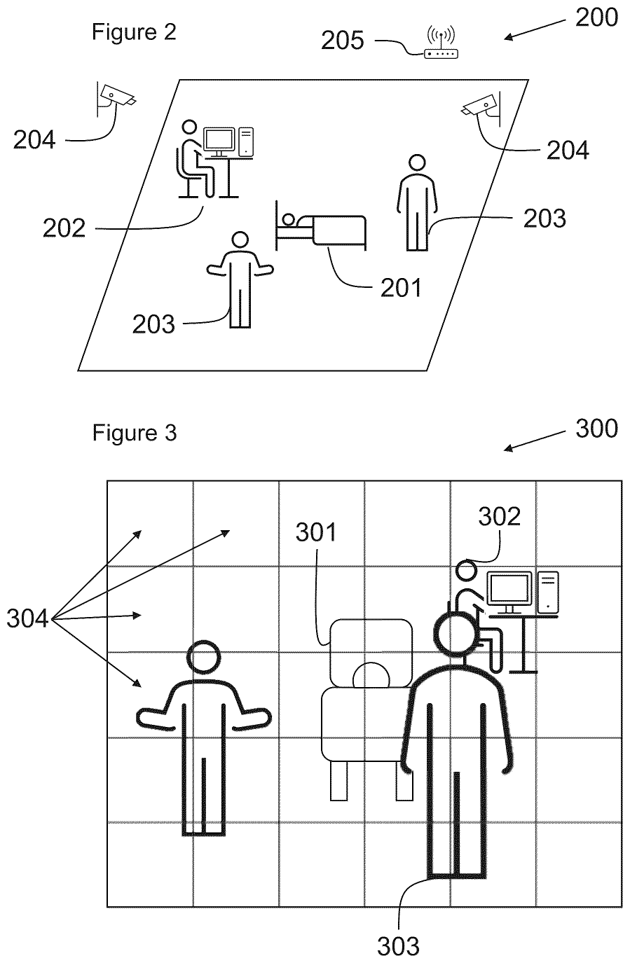

FIG. 2 shows an example 3D volume 200 which may be referred to herein for illustrating parts of the method 100 described with reference to FIG. 1. This 3D volume 200 comprises a patient in a bed 201, an assistant at a computer 202, and two surgeons 203.

Either within or outside of the 3D volume are one or more spatial representation capture devices 204, 205. The spatial representation capture devices 204, 205 may be any suitable devices which capture 2D or 3D spatial representations of the 3D volume 200. In the most straightforward examples, one or more of the spatial representation capture devices 204, 205 may be photo or video cameras 204 (image cameras) which use light within the visible spectrum to capture 2D images of the 3D volume 200. In other embodiments, one or more of the spatial representation capture devices may be lidar sensors, radar sensors, wifi sensing systems 205, IR sensors, pressure (weight) sensors, microphones, or any other suitable sensor which is able to capture information about the contents of the 3D volume 200. In some embodiments, at least two of the plurality of spatial representations may be captured by different types of spatial representation capture devices 204, 205. In other embodiments, all of the plurality of spatial representations may be captured by the same type of spatial representation capture device 204,205.

FIG. 3 shows an example 2D spatial representation 300 of the 3D volume 200 represented in FIG. 2. 2D spatial representations 300 of the 3D volume are straightforward to picture, as these may be direct photographs, still images from a video feed or another type of representation which does not provide depth information. While images are the easiest type of spatial representation to imagine, it will be appreciated that not all 2D representations are necessarily images made up of image data which are representative of visible light captured by image sensors. Instead, other types of 2D spatial representations may include images captured by a camera comprising a rectilinear lens, a camera comprising a fish-eye lens or a lens comprising a different type of lens. In other examples, a wifi raw signal may be configured to generate a 2D spatial representation. In yet other examples, a 2D spatial representation may be a bird's-eye-view of a space captured by an appropriate 2D spatial representation capture device. A further example of a 2D spatial representation may be an event camera configured to measure changes in brightness. A yet further example of a 2D spatial representation may be any 1D signal, 1D spatial representation or plurality of 1D spatial representations which can be parameterised as 2D signals. Such parameterisation of 1D data into a 2D spatial representation may be achieved by way of manual parameterisation or by way of digital processing, such as by an ML algorithm.

It will be appreciated that in 2D spatial representations 300 of a 3D volume, it is possible for some objects to obscure other objects, depending on the point of view from which the spatial representation is captured. For illustrative purposes, in the example of FIG. 3, part of the bed 301 and the assistant 302 at the computer are partially obscured by one of the surgeons 303. It is not possible to know, without additional information, exactly what is behind the obscuring surgeon 303. Human vision allows us to discern the depth of various objects in 2D spatial representation 300 like an image by way of our understanding of depth, perspective and relative object positions. This information is not inherent in an image without undertaking processing steps to process the information that a human would determine instinctively. Thus, in order to build up a complete understanding of the contents of the 3D volume 200, it is necessary to obtain a plurality of spatial representations of the 3D volume, preferably, but not essentially, from different points of view within the 3D volume.

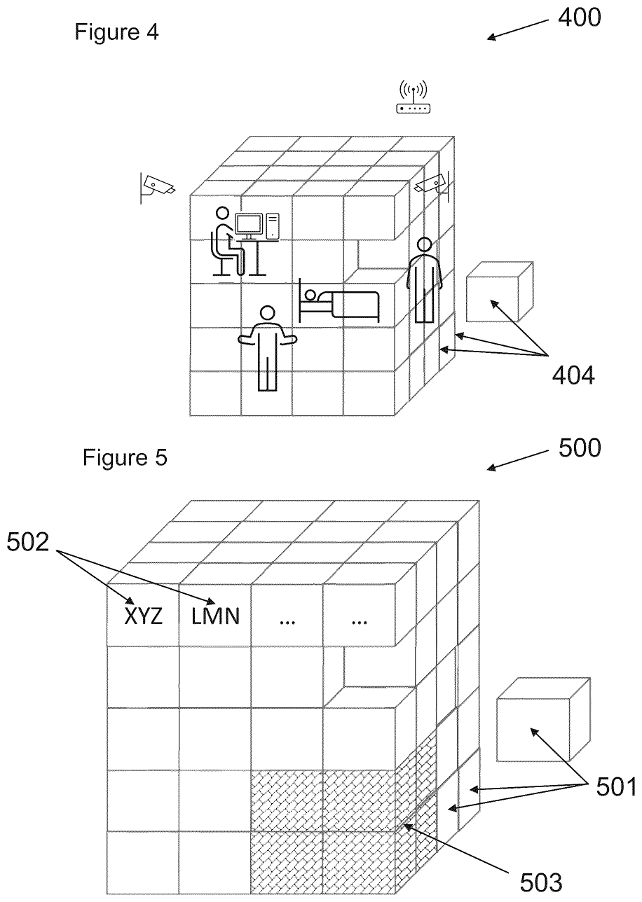

FIG. 4 shows an example 3D spatial representation 400 of the 3D volume. 3D spatial representations 400 of the 3D volume 200 may be, for example, a lidar point cloud which, in addition to providing information about the contents of the volume in two dimensions, also provides depth information for the objects identified. That is, each point in the point cloud may comprise a value which together define the 3D position of the objects which are visible to the lidar detector within the 3D volume. Certain types of 3D spatial representation 400, such as a lidar point cloud may still allow for some objects to be obscured by other objects. For example, if the 3D spatial representation 400 capture device relies on interrogation signal reflections from a distant object, then objects behind the object from which reflections occur may not be detected. Other examples of 3D spatial representation capture devices may be able to obtain information about the position of objects within the 3D volume without being limited by object obscurement. For example, wifi sensing systems allow for the detection of objects in a 3D volume by detecting changes in attenuation of wifi signals through the volume. Such systems are able to detect objects within a volume regardless of obstruction by objects.

Each spatial representation is captured using one or more spatial representation capture devices 204, 205 from a position within, or outside of, the 3D volume 200 such that each spatial representation is captured from a “point of view” of the 3D volume. In the case of image capture devices 204, 205, it will be understood that the point of view of the image capture device 204, 205 is the position of the image capture device relative to the 3D volume 200. Similarly, a lidar device may also capture its spatial representations from a particular position within or outside of the 3D volume and, as such, the position of the lidar detector defines the detector's point of view. Point of view information, as will be discussed later, is important when it comes to aggregating or otherwise combining data associated with the spatial representations. It will be appreciated that a point of view indicates that the spatial representation capture device 204, 205 in question is able to capture a representation of the 3D volume.

In the cases of cameras 204 and similar optical wavelength light-based spatial representation capture devices, these sensors may require a direct (unobscured) view of the room. In the case of spatial representation capture devices which are able to transmit their detection signals through solid objects such as wifi sensors 205, the sensors may be in a different room but due to the fact that their detection signals can travel through walls and other objects, these sensors still have a “view” of the room of 3D volume of interest. Thus, some types of sensors may not have a visual view of the room but may still be able to detect objects within the 3D volume. The point of view information of any spatial representation capture device 204, 205 will be based on the position of the sensor relative to the 3D volume 200. If a representation is not spatial, it may be treated as 1D representation. Any 2D and 3D representation may be considered a 1D representation by ignoring its spatial information (e.g. tensor stride). For example, a wifi sensor or microphone array may produce a 1D signal to be processed by an ML algorithm that then produces a 3D point cloud that our system can use). 1D representations may be used directly to describe the 3D volume in its entirety. For example, a high-quality microphone may be able to hear everything in a room.

Each type of spatial representation 300, 400 which can be captured in order to provide information about the contents of a 3D volume may have its own strengths and weaknesses. As such, it is desirable to provide a system and method which is able to aggregate different types of spatial representations.

The computer implemented method 100 of detecting the position of an object in a 3D volume comprises a step of receiving 101 a plurality of captured spatial representations 300, 400 wherein each spatial representation 300, 400 comprises a representation of the 3D volume and wherein each spatial representation 300, 400 is captured from a point of view of the 3D volume 200. Each spatial representation 300, 400 is one of a 2D spatial representation 300 and a 3D spatial representation 400, as has been described above. As further described above, receiving 100 a plurality of the captured spatial representations allows for the provision of more information than a single spatial representation can provide about the contents of the 3D volume.

The method further comprises, for each 2D spatial representation 300, defining 102 a plurality of segments 304 of the 2D representation wherein each segment 304 defines an area of the 2D representation 300. FIG. 3 shows an example of a 2D representation 300 which has been segmented as described. While the segmentation shown in FIG. 3 is presented as a uniform square grid, it will be appreciated that the segments need not necessarily be square and nor do they need to be uniform. The segmentation of the 2D representations 300 may be performed using any suitable segmentation approach. In some examples, for example, each pixel, or a single pixel, may be possible segments.

FIG. 4 shows an example 3D spatial representation 400 which has been separated into a plurality of representation voxels 404. A voxel is a sub-volume of a 3D volume and can be considered as the 3D equivalent of a pixel. The method further comprises, for each 3D spatial representation, defining 103 a plurality of representation voxels 404 of the 3D spatial representation 400 wherein each representation voxel 404 defines a sub-volume of the 3D volume 200. The term “representation voxel” 404 is used herein in order clearly distinguish representation voxels 404 from other types of voxels described later in this disclosure and is not intended to impart any additional meaning to the voxels. While the voxelization into representation voxels in FIG. 4 is shown to result in a uniform grid of cubes, it will be appreciated that the representation voxels need not necessarily be cubes and nor do they need to be uniform. The voxelization of the 3D spatial representation 400 may be performed using any suitable voxelization approach.

It will be appreciated that, in some embodiments, all of the spatial representations used in the method may be 2D spatial representations 300. As a result, in these embodiments, the steps associated with the 3D spatial representations 400 may not be performed because there are no 3D spatial representations 400 to perform these steps on. In other embodiments, all of the spatial representations may be 3D spatial representations 400. As a result, in these embodiments, the steps associated with the 2D spatial representations 300 may not be performed because there are no 2D spatial representations 300 to perform these steps on. In yet other embodiments, the plurality of spatial representations may comprise a mix of 2D and 3D spatial representations 300, 400. In such embodiments, all of the steps relating to both 2D and 3D spatial representations 300, 400 may be performed.

The method 100 further comprises assigning 104 a first prediction score to each segment 304 of each 2D spatial representation 300. Further, the method comprises assigning a first prediction score to each representation voxel 404 of each 3D spatial representation 400. Each first prediction score is indicative of a confidence that the segment or representation voxel 404 comprises a particular object, such as a first object. The prediction scores may be assigned, for example, by a predictive machine learning algorithm which has been trained to identify a particular type of object. By way of non-limiting example, the predictive algorithm may be trained to identify a human hand. The predictive algorithm may be run on each spatial representation 300, 400 as a whole, or on a part of it, and each segment 304 or representation voxel 404 may be assigned the first prediction score indicative of the likelihood that the segment 304 or prediction voxel 404 contains a hand, or part of a hand, within it. Importantly, at this stage, the method 100 may not comprise a step of determining that a segment 304 or representation voxel 404 comprises a hand, that is, the segments 304 or representation voxels 404 will not be labelled as containing a hand. Instead, only a score indicative of the predicted likelihood of a hand being contained therein will be assigned. A final decision on whether a hand is present is made at a later point in the method.

The step of assigning prediction scores to each segment of each 2D spatial representation and to each representation voxel of each 3D representation may be repeated a plurality of times, with each subsequent repetition assigning an additional different prediction score (such as a second, third fourth prediction score) representative of a confidence that the segment or representation voxel comprises a second, third or fourth object, respectively. That is, where the first prediction score may be indicative of the confidence of a hand being contained within the associated segment or representation voxel, a second prediction score may be indicative of the confidence of an elbow being within the associated segment or representation voxel, and a third prediction score may be indicative of the confidence of a scalpel being within the associated segment or representation voxel.

The further prediction scores (such as the second, third, fourth prediction scores) may be assigned to the same segments 304 or representation voxels 404 as the first prediction score. In other embodiments, the preceding steps of segmenting and voxelizing the spatial representations may be performed in order to obtain segments 304 or representation voxels 404 of different areas or volumes, respectively, for one or more of the further (second, third, fourth, etc) prediction scores. This may be done, for example, if a particular object is expected to be smaller or larger than another. In such an instance, the spatial representations may be segmented or voxelized into smaller or larger segments 304 or representation voxels 404, respectively, when assigning prediction scores for objects which are, or tend to be, smaller or larger than others, respectively.

FIG. 5 shows an example of an array 500 of array voxels 501. The method further comprises generating 105 an array 500 representative of the 3D volume 200 wherein the array 500 defines a plurality of array voxels 501 wherein each array voxel 501 is representative of a different sub-volume of the 3D volume 200. Where the representation voxels 404 represent voxelizations of the 3D volume 200 represented in each 3D spatial representation 400, the array voxels 501 define a plurality of voxels which can be used to represent the whole 3D volume, the 3D volume of interest. It will be appreciated that some 3D spatial representations may not provide representations (views) of the entire 3D volume 200 but array voxels 501 are provided such that one array voxel 501 corresponds to each sub-volume of the 3D volume of interest. Further, where the representation voxels 404 represent a voxelization of an image or other 3D spatial representation 400, the array voxels 501 may provide a mathematical construct which can be populated, as described later, to be mathematically representative of the 3D volume 200 and its contents. The array voxels 501 may be structured as a multidimensional array such as a vector, matrix or tensor of elements where each element of the multidimensional array represents a sub-volume of the 3D volume 200. Each element in the vector, matrix or tensor may be a feature vector or it may comprise a plurality of feature vectors.

A feature vector may be a numerical representation of one or more of the contents of a sub-volume, the potential contents of the sub-volume, the location of the sub-volume and any other characteristic of the sub-volume. The feature vector may be provided in a form that can be processed by a machine learning algorithm. Thus, while the individual entries in the array 500 are referred to as array voxels 501, it will be appreciated that this nomenclature is used for ease of visualisation and provides general nomenclature to encompass the plurality of mathematical constructs which may be used. Each entry in the array (array voxel) is a feature vector or other mathematical construct which is representative of the contents of a sub-volume of its associated the sub-volume, the potential contents of the sub-volume, the location of the sub-vole and any other characteristics of the sub-volume. The plurality of array voxels 501 may represent a voxel grid, parametrised by centres in real-world coordinates and dimensions which are implied by grid size and density.

In embodiments wherein the elements of the array (the array voxels 501) are feature vectors, the feature vectors may comprise one or more separate numerical values. Each of the numerical values may provide different information about the contents of the corresponding sub-volume of the 3D volume of interest. For example, the feature vector may comprise the first and second and, optionally, higher-order aggregated prediction scores (voxel scores) indicative of the confidence that a first and second and, optionally, higher-order different types of objects are present within the sub-volume of the 3D volume represented by the array voxels 501.

The array voxels 501 and the representation voxels 404 may be representative of sub-volumes of the same size while in other embodiments, the representation voxels 404 into which each 3D spatial representation 400 is voxelized may be representative of a different sized sub-volume of the 3D volume to those of the array voxels 501.

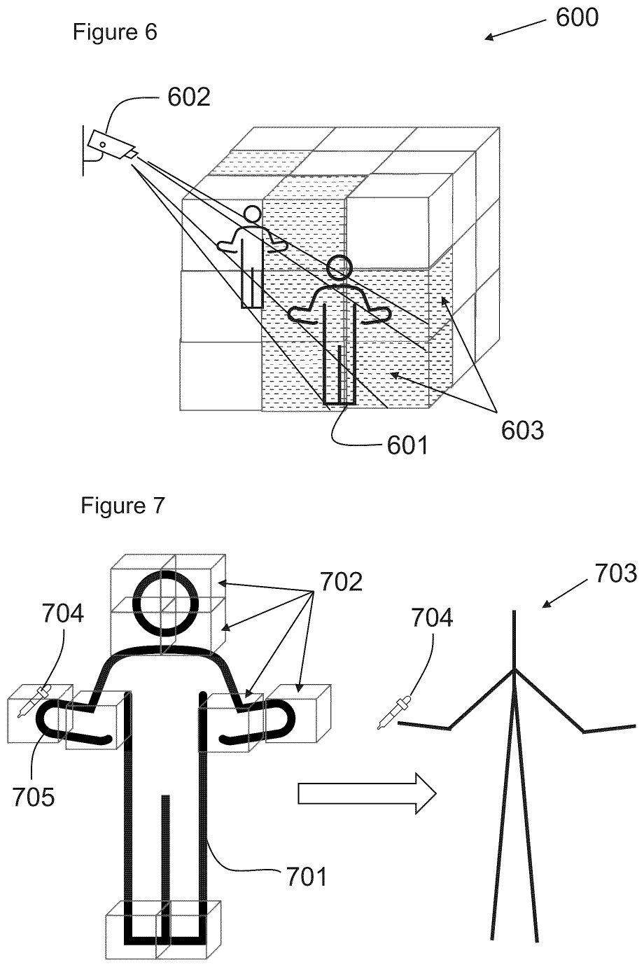

FIG. 6 shows an example 3D volume 600 in which a person 601 is standing. Also shown in FIG. 6 is a projection of the possible positions (depths through the 3D volume) at which that person 601 may be standing when viewed from the position of the camera 602, which are represented by the lines extending between the two figures. The pattern-shaded voxels 603 indicate the voxels with which the potential positions of the person 601 intersect.

As alluded to above, when considering a 2D spatial representation 300 without contextual information, it is not possible, or it is at least very difficult, to know at what depth within the representation 300 an object may be situated. As such, in order to avoid assumptions, one may consider that the object is located at all possible depths through the 3D volume 600 which can be traced from the spatial representation capture device 602 to the edge of the 3D volume 600. Since the camera 602, in this example, has a limited perspective projection, the possible positions at which the object (person 601 in this example) may be located within the 3D volume 600 can be determined by projecting rays from the spatial representation capture device 602 that intersect with the edges of the object. The object 601 may be located at any position through the 3D volume 600 through which the projected rays pass. The voxels in which the object 601 may be located may be considered to be any voxel which intersects with a ray of the object 601 through the 3D volume 600. In this way, it can be seen that the point of view information associated with the 2D spatial representation (the point of view of the spatial representation capture device 602 which captured the 2D spatial representation in question) is an important component in identifying where in the 3D volume the object 601 may potentially be located.

Thus, in order to capture the possible positions at which an object 601 may be located in the 3D volume 600 when seen in a 2D spatial representation, the method 100 further comprises a step of associating each segment 304 of each 2D spatial representation with a plurality of the array voxels 501 within the array 500 based on the point of view from which the respective 2D spatial representation 300 was captured. The array voxels 501 associated with each segment 304 are those which are representative of positions of the segment 304 at potential depths through the 3D volume 600 at which the contents of the 2D spatial representation 300 may be positioned. This may result in a plurality of array voxels 501 in a line which are all associated with a single segment 304 of a 2D spatial representation 3000, as depicted by way of the pattern-filled voxels 603 in FIG. 6. It will be appreciated that associating the segments 304 and array voxels 501 may comprise the step of identifying which segments 304 correspond to the various array voxels 501. This step can be used, as will be described below, for assigning the first prediction scores from the 2D spatial representations 300 directly into the array 500.

Associating 106 the representation voxels 404 of the or each 3D spatial representation with the array voxels 501 of the array 500 may comprise identifying, for each representation voxel 404, which array voxel 501 or array voxels 501 are representative of the volume represented by the representation voxel 404 and then associating the identified representation voxels 404 and array voxels 501. The point of view of the spatial representation capture device 204, 205, 602 used to capture the 3D spatial representation 400 can be used to orient the 3D spatial representation 400 relative to the array 500 of array voxels 501 so that the representation voxels 404 can properly and consistently be associated with the correct array voxels 501. It will be appreciated that associating the representation voxels 404 and array voxels 501 may comprise the step of identifying which voxels correspond to one-another. This can be used, as will be described below, for assigning the first prediction scores from the 3D spatial representations 400 directly into the array 500.

Thus, the method 100 further comprises associating 106 each representation voxel 404 of each 3D spatial representation 400 with at least one array voxel 501 based on the point of view from which the respective 3D spatial representation 400 was captured.

Once the segments 304 of the 2D spatial representations 300 and the representation voxels 404 of the 3D spatial representations 400 have been associated with the array voxels 501 of the array 500, a first voxel score 502 can be assigned to each array voxel 501. The voxel score 502 for each array voxel 501 is based on the first prediction score associated with each segment 304 associated with the array voxel 501 and is further based on the first prediction score associated with each representation voxel 404 associated with the respective array voxel 501. The first voxel score 502 may represent an aggregation of the first prediction scores of each of the segments 304 and/or representation voxels 404. The first prediction scores may be, for example, added together, multiplied together or otherwise mathematically combined in order to provide the first voxel scores 502. The first voxel scores 502 may be representative of the aggregate probability of the type of object associated with the first prediction score being present within the voxel (sub-volume) in the 3D volume 200 represented by the array voxel 501.

Lines of array voxels 501 at different depths through the array 500 will be assigned with prediction scores resulting from a single segment 304 of a 2D spatial representation 300 of the 3D volume 200, as has been described with reference to FIG. 6. By using a second spatial representation, which may be 2D or 3D, the aggregated prediction scores in the form of the voxel scores will be likely to provide a higher probability or confidence that an object is at its true location within the 3D volume than if only a single spatial representation were relied upon. In one or more embodiments, at least one 2D spatial representation and at least one 3D representation may be used.

By way of example, in one or more embodiments, two or more 2D spatial representations 300 may be used. In such embodiments, it may be beneficial for at least two of the 2D spatial representations 300 to be captured from different points of view of the 3D volume 200. By way of their different points of view of the 3D volume 200, the two 2D spatial representations 300 will result in two lines of array voxels 501 at different depths through the array 500 which are provided at a non-zero angle relative to each other. Where the same object is present in both 2D spatial representations 300, a point of intersection between the first prediction scores will occur at or very close to the true location of the object of interest. The more spatial representations that are used (be they 2D or 3D), the more likely it is that the prediction scores will aggregate together to provide a voxel score which is indicative of the object at an array voxel 501 representative of the correct location within the true 3D volume 200.

Where each array voxel 501 is represented by a feature vector, the voxel score may be one numerical entry within the feature vector and, as such, the feature vector may be comprised of a plurality of different voxel scores 502 each representative of the aggregate prediction score indicative of the confidence of the classification algorithm or other classifier of a particular object being present within the sub-volume represented by the array voxel 501.

The computer implemented method further comprises, after assigning 106 the first voxels scores to their associated array voxels 501, using a classification algorithm to classify an object within the 3D volume 200 based on the first voxel scores. Whereas earlier in the method, prediction scores were assigned to each of the segments 304 or representation voxels 404 of the spatial representations 300, 400 which were indicative of a confidence of a prediction that a particular object is present in that segment 304 or representation voxel 404, this step of using the classification algorithm to classify the object is the point at which a particular label (classification) is assigned. By not making a firm classification, or applying a label, to any of the spatial representations 300, 400 and, instead, relying on prediction scores across the whole spatial representation until all of the prediction scores have been aggregated into the voxel scores 502 in the array 500, computational power can be saved and more accurate results can also be achieved. Additional benefits of late decision making include adapting the discretization to tune the computational complexity according to the complexity of the scene and the option to reuse inference components.

In one or more embodiments, the classification algorithm may be used on the array voxels 501 of the array 500 discussed above. In other embodiments, however, it may be desirable to perform further processing of the data and obtain a higher resolution data about a particular region of interest of the 3D volume before taking the final step of using the classification algorithm to classify an object within the 3D volume. For example, it may be desirable to determine the position of a scalpel within the 3D volume. In such an example, reviewing all of, or the majority of, the initial spatial representations (those used in the first classification pass) may need to be done at a low resolution in order to utilise processing resources efficiently. Such a low resolution may identify that the scalpel is within a voxel of the 3D volume that is large relative to the size of the scalpel. As such, the resolution on the position of the scalpel may be low. Thus, it may be desirable to select a region of interest (ROI) 503 around the scalpel (or whatever the object of interest is), which may be one or more voxels of the initial 3D volume represented by one or more array voxels 501. An example ROI 503 is represented by a plurality of pattern-filled voxels in FIG. 5. It may be then of interest to either use the same spatial representations 300, 400 again with segmentation or voxelization performed at a higher resolution or to use entirely new spatial representations to perform the above method again at the higher resolution in order to focus on the region of interest 503 and, in doing so, arrive at a region of interest (ROI) array comprised of ROI array voxels that each comprise ROI voxel scores indicative of a confidence value of the object of interest being within those ROI array voxels. The step of using the classification algorithm to classify an object within the 3D volume may then be performed in order to obtain a classification (label) for the object within the ROI of the 3D volume and, thereby, identify the position of the object within the ROI of the 3D volume. The steps required to implement this refinement process are outlined in further detail below. Steps which mimic those described with reference to the initial steps of the method will not be described again in detail apart from where there are deviations in aspects of the steps.

Thus, in embodiments wherein it is desirable to obtain higher-resolution data, the method may further comprise, before the step of using a classification algorithm to classify an object within the 3D volume based on the first voxel scores, determining a region of interest 503 based on the first voxel scores 502 of the array voxels 501 wherein the region of interest 503 is a region of the 3D volume 200 that is represented by one or more array voxels 501. For example, the ROI may be determined as the array voxel 501 or array voxels 501 of the array 500 which have the highest voxel score 502, the lowest voxel score 502, a voxel score 502 within predetermined bounds, a voxel score 502 above a predetermined threshold score or below a predetermined threshold score. The exact method of determination of the ROI does not matter exactly and may be impacted by the form which the voxel scores 502 take and the mathematical aggregation methodology utilised to aggregate the prediction scores to form the voxel scores 502.

The method further comprises receiving a focussed plurality of spatial representations wherein the focussed plurality of spatial representations comprises spatial representations that comprise the region of interest 503. The focussed plurality of spatial representations may be the same spatial representations 300, 400 that were used to obtain the initial prediction scores and ultimately populate the array voxels 501 of the array 500. In other embodiments, the focussed plurality of spatial representations may be a sub-group of the plurality of spatial representations 300, 400 used to obtain the initial prediction scores. For example, it may be that some spatial representations do not include the ROI 503 due to their point of view. Further, some spatial representations of the original plurality of spatial representations may not include the ROI 503 because it is obscured by another object that is in the foreground of the spatial representation. In other examples, the focussed plurality of spatial representations may be different to those that were used to determine the initial prediction scores. The new spatial representations may be selected because they were taken at a higher resolution than the initial spatial representations, because the view of the ROI 503 is less obstructed than the view in the initial spatial representations or for any other suitable reason. In yet other embodiments, the focussed plurality of spatial representations may include one or more spatial representations of the initial plurality of spatial representations and one or more new (previously unused) spatial representations.

The method may further comprise, for each 2D spatial representation of the focussed plurality of spatial representations, defining a plurality of ROI segments of the 2D representation wherein each ROI segment defines an area of the region of interest. That is, the process of segmenting the 2D spatial representations used in the initial pass of the method is repeated for the focussed plurality of spatial representations. In one or more embodiments, the segments into which the 2D focussed spatial representations are segmented may be smaller than the segments (relative to the 3D volume) into which the initial spatial representations were segmented. This may provide for higher resolution segmentation of the ROI of the 3D volume. In other embodiments, a higher resolution may not be the improvement sought by the second pass of the method using the focussed plurality of spatial representations and, as such, the segments may be the same size or, optionally, larger than the segments which were defined with respect to the initial spatial representations.

Similarly, the method may further comprise, for each 3D focussed spatial representation of the plurality of focussed spatial representations, defining a plurality of ROI representation voxels of the 3D focussed spatial representation wherein each ROI representation voxel defines a sub-volume of the region of interest 503. That is, the process of voxelizing the 3D spatial representations used in the initial pass of the method is repeated for the focussed plurality of spatial representations. In one or more embodiments, the voxels into which the 3D spatial representations are voxelized may be smaller than the voxels (relative to the 3D volume) into which the initial spatial representations were voxelized. This may provide for higher resolution voxelization of the ROI of the 3D volume. In other embodiments, a higher resolution may not be the improvement sought by the second pass of the method using the focussed plurality of spatial representations and, as such, the voxels may be the same size or, optionally, larger than the voxels which were defined with respect to the initial spatial representations.

The method may further comprise assigning a first focussed prediction score to each ROI segment of each 2D spatial representation of the focussed plurality of spatial representations. Yet further, the method may comprise assigning a first focussed prediction score to each ROI representation voxel of each 3D spatial representation of the focussed plurality of spatial representations. The first focussed prediction score is based on a confidence that the ROI segment or ROI representation voxel comprises a first object. Again, the first prediction score may be assigned using a classification algorithm or another type of algorithm which provides an indication of the confidence of the algorithm that the object of interest is in the ROI segment or ROI representation voxel.

The method may further comprise generating an ROI array representative of the region of interest of the 3D volume wherein the array comprises a plurality of ROI array voxels. Each ROI array voxel is representative of a different sub-volume of the region of interest. The size sub-volumes represented by the ROI array voxels relative to the 3D volume may be similar or the same as the size of the sub-volumes represented by array voxels of the initial array. In other embodiments, one or more of the ROI array voxels may represent smaller sub-volumes than those represented by the array voxels in order to provide for higher resolution determinations of the position of the object or objects of interest. In other examples, the original array 500 or a sub-set of the array voxels 501 of the original array 500 may be used as the ROI array and so the step of generating the ROI array may not be necessary, or such a step may involve only defining which array voxels 501 of the plurality of array voxels 501 will be used to review the ROI.

The method may further comprise a step of associating each ROI segment of each 2D spatial representation of the focussed plurality of spatial representations with a plurality of ROI voxels within the ROI array based on the point of view from which each respective 2D spatial representation was captured. As was the case for associating the 2D spatial representations 300 of the initial plurality of spatial representations and the array voxels 501, the ROI array voxels associated with each ROI segment are those which are representative of positions of the ROI segment at potential depths through the 3D volume 200 at which the contents of the 2D spatial representation may be positioned based on the point of view from which the 2D spatial representation was captured. This association may be performed as has been described with reference to FIG. 6.

The method may further comprise, for each ROI representation voxel of each 3D spatial representation of the focussed plurality of spatial representations with at least one ROI array voxel based on the point of view from which the respective 3D spatial representation was captured.

The method may then comprise assigning a first focussed voxel score to each ROI array voxel wherein each first focussed voxel score is based on the first focussed prediction score associated with each ROI segment associated with the respective ROI array voxel. Each first focussed voxel score may also be based on each first focussed prediction score associated with each ROI representation voxel associated with the respective ROI array voxel. As for the initial iteration of the method, the first focussed voxel scores may be feature vectors or they may be elements within a feature vector.

Finally, the method comprises performing the step of using the classification algorithm to classify an object within the 3D volume further based on the first focussed voxel scores.

It will be appreciated that using the classification algorithm to classify an object within the 3D volume represented by the array or ROI array may be performed either directly in the overall 3D volume or in a specific region of interest. Where the classification algorithm is run on the 3D volume as a whole, then the classification of objects may be based directly on the first voxel scores, i.e., the first voxel scores are fed into the classification algorithm in order to determine the position of the first object within the 3D volume. Where the classification is performed in the region of interest using the ROI array, the classification of the object may be based directly on the first focussed voxel scores, i.e., the first focussed voxel scores are fed into the classification algorithm in order to determine the position of the first object within the 3D volume. In such an embodiment, the classification may also be based on the first voxel scores indirectly since the first voxel scores have resulted in the definition of the region of interest and, potentially, the selection of the focussed plurality of spatial representations. In some embodiments, the classification algorithm may use both the first voxel scores 502 and the first focussed voxel scores when running the classification algorithm to identify the objects within the ROI.

The above-described process of refining the object position determination by considering a region of interest may be performed any number of times before the final step of using the classification algorithm to classify an object within the 3D volume. That is, it will be appreciated that a second, third or higher-order time through the ROI method may be performed in order to steadily focus in on more and more specific regions of interest within the 3D volume in order to achieve higher-resolution determinations of the position of, for example, a first object. In embodiments that use higher-order iterations of the ROI method, the step of using the classification algorithm to classify an object within the 3D volume will be performed using at least the most recent (highest order) focussed voxel scores.

As above, the method may be repeated for any number of objects of interest. That is, the method may be repeated for a plurality of different classifications. Such additional iterations through the method may include repeating the steps of assigning predictions scores, which may be second, third or fourth prediction scores. Each additional prediction score may be indicative of a confidence of a classification algorithm that a different object is contained within the segment or representation voxel in question. Such a repeated method for additional object detection may not require the re-generation of the array 500 or the re-association of the segments 304 and representation voxels 404 with the array voxels 501, as the original segments 304, representation voxels 404 and array voxels 501 may be used. In other embodiments, one or more of these steps may be repeated in order to generate a new array with array voxels representative of different volumes to those used for the detection of the first object position. The method may further comprise assigning the second, third, fourth or higher-order voxel scores to the array voxels based on the prediction scores of the segments and representation voxels. These higher-order voxel scores may be indicative of an aggregate confidence that a second, third, fourth or higher-order object can be found within the corresponding array voxel 501. These higher-order voxel scores (those of second order onwards) may be assigned to the feature vectors associated with the array voxels 501. The classification algorithm may then be used on the second, third, fourth and/or higher-order voxel scores in order to determine the position of the second, third, fourth and/or higher-order objects.

Any steps described with reference to determining the position or other features of the first object may equally be applied to determining the position or other features of the second, third, fourth or higher-order objects. As such, the position of the second, third, fourth or higher-order objects within a ROI may be determined as has already been described. The ROI may be the same ROI used with respect to the first object or the ROI may be different, since the second object may be in the same region of the 3D volume as the first object or in a different region. In repeating the method within an ROI of the second object, a second focussed voxel score may be assigned based on second focussed prediction scores. The second focussed prediction scores may be incorporated into the feature vectors of the corresponding ROI array voxels. The classification algorithm may then be used to identify the position of the second object based on the second focussed voxel scores and, directly or indirectly, on the second voxel scores.

FIG. 7 shows an example of how objects and various points on a human body 701 may be identified to be present within volumes represented by array voxels 702 and how these determinations can be used to build a skeleton 703 of associated and interrelated objects. FIG. 7 shows an overlap of a person 701 in the 3D volume with array voxels 702 representative of 3D volume. Such a set of interrelations can be beneficial for both identifying the context of what is happening within the 3D volume and for tracking the objects as they move through time, which can be captured in a plurality of temporally-spaced spatial representations. Defining an interrelation between two objects may comprise incorporating data indicative of the interrelation into the feature vector or feature vectors associated with the objects or the array voxels which comprise data indicative of their positions. In other examples, defining the interrelation between two objects may comprise defining the interrelation between the two objects separately from the feature vectors, such as in an interrelation database, wherein the interrelation data can be accessed and utilised by the method.

Where the positions within the 3D volume of two or more different objects have been identified, it may be beneficial to be able to determine interrelations between the identified objects. The interrelations between two objects may take several different forms and each different type of interrelation may provide different information to an operator of an object position detection system or an object tracking software. The determination of an interrelation between a first object and a second object may be made based on predetermined interrelation information. The predetermined interrelation information may be a library of potential interrelations which may be expected to occur within the 3D volume and may provide one or more indicators which can be used to determine if an interrelation exists.

The feature vectors associated with the array voxels may comprise information which is used by an interrelation algorithm that further uses the predetermined interrelation information to determine an interrelation between two objections and, based on the determination of the interrelation, record the interrelation as described above. Upon an interrelation between a first and second object being determined, the feature vectors associated with each of the first and second objects may be updated to incorporate the interrelation data indicative of the interrelation. In one or more embodiments, a new feature vector may be defined which is representative of both the first object, the second object and their interrelation.

The predetermined interrelation information may indicate that a hand and an elbow may belong to the same person if a forearm can be detected to extend directly between the hand and the elbow. That is, the first and second object may be interrelated if a third object is detected between the first and second objects.

The predetermined interrelation information may be information about an acceptable or expected distance between the first object and the second object. To use the example of a hand and an elbow again, the hand and elbow may have a high chance of being interrelated (belonging to the same person, in this case) if they are within a particular distance of each-other within the 3D volume. This distance between the two objects can be determined based on the difference in position of the two array voxels that contain the respective objects.

Further predetermined interrelation information may include an angle between the first object and the second object. The angle may be an angle of the first object and the second object when measured about a point within the 3D volume. For example, a shoulder and a hand may be separated by an acceptable distance from each other, but the angle between the two relative to an elbow may indicate that the two cannot physically belong to each other (unless part of the arm has been broken).

In another example, the predetermined interrelation information may be information that indicates that a syringe may be held by a person if part of the hand of the user can be seen to obscure part of the syringe.

Further interrelation information in this example might indicate that the syringe is being held if the ratio of the size of the syringe to the hand is within particular acceptable bounds. If the ratio of the size of the syringe to the hand is outside of the acceptable bounds, then this may indicate that the syringe is simply behind the hand and deeper into the image than the hand.

The predetermined interrelation information may be the identity of the first object and the second object. For example, it may be known that only one of a first object and one of a second object exist within the 3D volume and, if they have both been identified within the 3D volume, then they should be considered to be interrelated with one-another.

In one or more embodiments, a bounding box for an object may be identified or defined. The bounding box may be identified during assignment of the prediction scores to the segments 304 and representation voxels 404 of the 2D and 3D spatial representations, respectively. For example, where a hand is present within 3 particular segments 304 of a 2D spatial representation 300, each of the segments 304 may be assigned with a prediction score indicative that there is a high likelihood of the presence of a hand within those segments 304. In addition to this assignment of prediction scores, a bounding box may be identified as extending around the three segments 304 in question wherein the bounding box indicates the same object may be contained within these three segments 304. The same can equally be applied to the drawing of a 3D bounding box when working with representation voxels 404.

Similarly, bounding boxes may be identified in the feature space defined by the array voxels 501 of the array 500. Where a plurality of array voxels 501 indicate the presence of a same type of object, a bounding box may be defined which incorporates the array voxels 501 which have been determined to comprise the object in question.

In other embodiments, the feature space may be deprojected into a virtual 2D or 3D spatial representation based on a selected virtual spatial representation capture device position. That is, one may select any position within or outside of the 3D volume from which one desires a virtual spatial representation to be generated and then deproject the feature data of the array voxels to generate data representative of how a spatial representation would be represented if captured from that position. Bounding boxes may be identified or generated in a virtual spatial representation in the same way as they may be identified or generated for a non-virtual spatial representation.

The interrelation information may comprise information that indicates that the overlap of bounding boxes of first and second objects in 2D or in 3D may be indicative of an interrelation of two objects. For example, the bounding boxes of a syringe 704 and a hand 705 overlap with each other, then this may be enough to identify, or reasonably assume, that an interrelation exists between the two, i.e., that the syringe is being held by the hand.

Yet further, the method may comprise receiving velocity information about one or more objects. The velocity information may be based on video or other spatial representation-based tracking of the position of the objects or it may be based on motion sensors which are not used for determinations of the position of the objects. For example, the velocity information may be received from one or more accelerometers or other movement sensors attached to the objects. The velocity information may be linear velocity information indicative of the movement of the object in a first linear direction through the 3D volume or it may be angular velocity information indicative of rotation of the object about a point. The predetermined interrelation information may include information about how two interrelated objects might be expected to move through the volume and, as such, either of the object positions and their identifies may be used in conjunction with velocity information about one or both objects in order to determine an interrelation between the two objects.

The method may comprise receiving acceleration information about one or more objects. The acceleration information may be based on video or other spatial representation-based tracking of the position of the objects or it may be based on motion sensors which are not used for determinations of the position of the objects. For example, acceleration information may be obtained from one or more accelerometers or other movement sensors attached to the objects. The acceleration information may be linear acceleration information indicative of the acceleration of the object in a first linear direction through the 2D volume or it may be angular acceleration information indicative of rotation of the object about a point. The predetermined interrelation information may include information about how two interrelated objects might be expected to accelerate through the volume and, as such, either of the object positions and their identifies may be used in conjunction with acceleration information about one or both objects to determine an interrelation between the two objects.

It will be appreciated that one, or a combination of types of predetermined interrelation information may be used to determine whether an interrelation exists between two objects.

The interrelation between two objects may be a physical interrelation wherein a physical interrelation is one in which the two objects are permanently and physically connected to one-another. For example, a hand may have a physical interrelation to an elbow of the same person. The elbow of the person may have a physical interrelation to the shoulder of the person. The hand and the shoulder may have a physical interrelation which allows for rotation about a third point, such as at the location of the elbow. Knowing that a particular hand, elbow, shoulder, head, etc, belong to the same person may allow for the determination of contextual information about what is happening within the 3D volume. For example, it may allow for the determination of a pose of a person and, if that pose indicates that they are one of the surgeons in an operating room leaning over the patient, it may indicate that they are currently in the midst of performing an operation. Further, identifying a physical interrelation may allow for the prediction of the movement of the two objects as they objects move through space over time. This may allow for computational efficiencies to be taken advantage of by making an assumption that the physical movement of the two objects are limited by predetermined constraints imposed by the interrelation between those objects. For example, it can be assumed that the distance between a hand and an elbow will not extend or contract since they are separated by a forearm of fixed length.

The interrelation between two objects may also be a circumstantial interrelation wherein a circumstantial interrelation is one in which two objects are interrelated by the current circumstances within the 3D volume. Such a circumstantial interrelation may not be permanent and so it may, for example, indicate that the two objects may move together while the circumstance in question is still in effect. For example, where a syringe has been picked up by a surgeon, the syringe and the hand of the surgeon may be circumstantially interrelated such that it can be assumed that the two will move together until such as point as the surgeon puts the syringe down, at which point the circumstance would end. If within the 3D volume, the surgeon is identified as leaning over the patient with a syringe in hand, this may provide different contextual information about what is happening in the 3D volume than if they have a scalpel or suture in their hand. Each circumstantial interrelation may allow for the current context of the 3D volume to be determined and it may also allow for predictions about the future movement of the circumstantially interrelated objects to be predicted. This may make tracking the positions of objects as they move through the space over time easier.

An example of a predetermined constraint between two interrelated objects may include a fixed distance between the first object and the second object. A further example of a predetermined constraint between two interrelated objects may include a fixed range of rotational movement of the second object about the first object.

Once the physical and circumstantial interrelations between objects in the 3D volume have been defined and recorded, and the constraints resultant from these interrelations have been determined and assigned, it may be possible to generate one or more skeletons 703 for pose estimation wherein the skeletons are made up of a series of key interrelated points. The pose of the overall object or person can be determined by tracking the movement of the individual objects that make up the overall object or person.

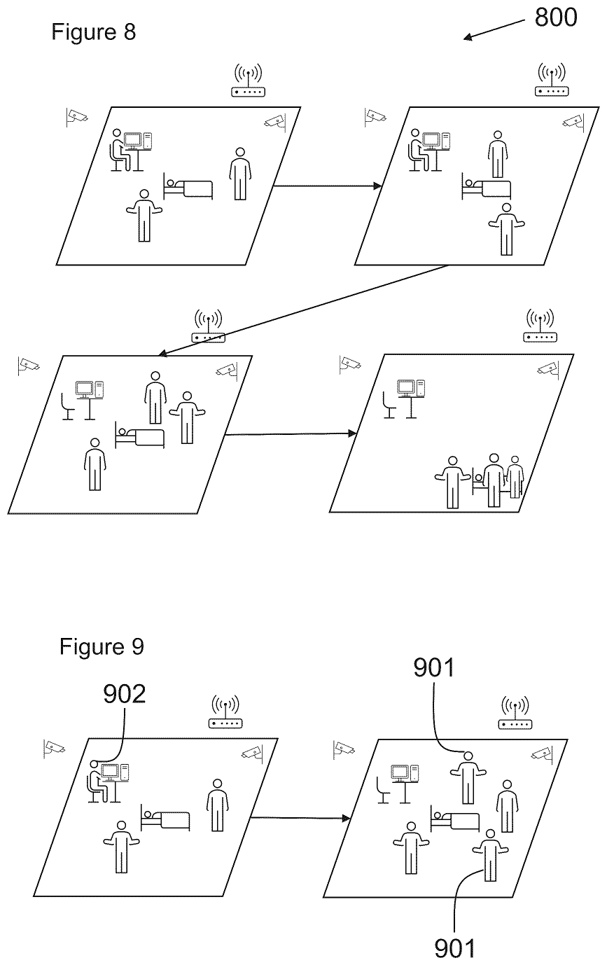

FIG. 8 shows an example of a sequence 800 of time-spaced depictions of a 3D volume representing how people and objects may move through a 3D volume over time. At each point in time, a plurality of different spatial representations may be captured from different points of view or from the same point of view using different spatial representation capture devices. In the example depicted in FIG. 8, the 3D volume may be captured over time using two video cameras and a wifi sensor system but it will be appreciated that other spatial representation capture devices may be used, as described above. The spatial representation capture devices may capture spatial representation substantially continuously or they may capture spatial representations of the 3D volume periodically.

Thus, for each spatial representation of the previously defined plurality of spatial representations, (each initial spatial representation of the plurality of spatial representations), there may be provided a plurality of additional spatial representations captured from the same points of view as their corresponding initial spatial representations at different points in time. The method may comprise receiving these additional spatial representations.

The method may further comprise tracking the changes in the position of the first object over the course of time based on the determination of the position of the first object within the 3D volume. For example, once the position of the object within the 3D volume has been determined, it may be possible to continue to determine the position of the object in the 3D volume at later points in time more easily by using the position of the first object represented in spatial representations representative of earlier points in time. Detection for a subsequent frame (spatial representation) based on a preceding frame (spatial representation) may be performed using a matching method. Example matching methods may include a Hungarian algorithm, a 1-nearest-neighbour algorithm, or any other linear assignment solver. Association between time-spaced spatial representations may be quantified by distance, bounding box overlap or arbitrary feature vector. In addition to matching detections, a Kalman filter may be optionally implemented which may provide for smoothing of matched detections. Each tracklet may receive a Kalman filter, and only smoothed positions may be saved as previous detections.

The method of tracking the position of first and second objects in each of the additional spatial representations (i.e., tracking first and second objects through the 3D volume over time) may include making use of one or more predetermined constraints. The predetermined constraints between the first and second objects may be determined based on the identification of an interrelation between the first and second objects or they may be determined in a different way. The predetermined constraints may define one or more of: a fixed distance between the first object and the second object; and a fixed range of rotational movement of the second object relative to the first object. Thus, the one or more predetermined constraints may be used to determine how the objects should be able to move within the 3D volume, thereby allowing for computational efficiencies to be taken advantage of.

FIG. 9 shows an example of how synthetic data may be generated from real data. In order to determine the position of one or more objects within the 3D volume, it may be necessary to first train a predictive ML algorithm. The training of a classification algorithm is not a simple task and requires large amounts of data. The amount of data for training an algorithm is generally limited and it may be desirable to obtain additional data different from the training data already available. It is not always practical to obtain additional real data, however, the generation of high-quality synthetic data provides a useful route to refining the training of a predictive ML algorithm. Using the array or ROI array generated in the presently described method, synthetic data can be generated which can be used to refine the training of a classification algorithm.

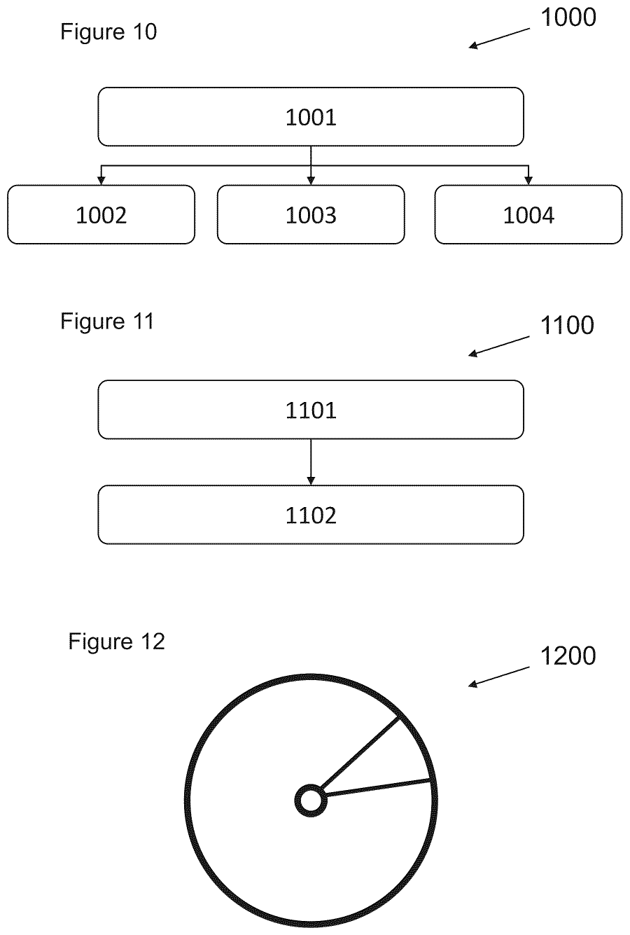

FIG. 10 shows an example method 1000 of generating synthetic data representative of a 3D volume. The method 1000 of generating synthetic data representative of the 3D volume may comprise receiving 1001 the array 500 representative of the 3D volume wherein the array 500 defines the plurality of array voxels 501, as already described. Each array voxel 501 is representative of a different sub-volume of the 3D volume and each array voxel 501 is associated with a feature vector indicative of the presence of one or more objects within the sub-volume represented by the array voxel 501. Each feature vector may be populated with one or more voxel scores 502 which provide the indications of the presence of one or more objects within the sub-volume. By manipulating the feature vectors, it is possible to adjust the position or presence of objects within the 3D volume, thereby creating synthetic data which can be used for training the algorithm further.

In one or more examples, the method 1000 of generating synthetic data may comprise receiving 1002 data indicative of a fictional object 901 and associating the fictional object with an array voxel, or more than one array voxel, by updating the feature vector indicative of the presence of one or more objects to incorporate the data indicative of the fictional object 901. Incorporating the data indicative of the fictional object 901 effectively introduces the object into the 3D volume represented by the array, thereby generating a synthetic piece of data which may be used for training. The fictional object 901 may be any object of interest, such as an animate or an inanimate object, as discussed above. If a plurality of fictional objects 901 are incorporated into the array, then a whole new person may be added, by adding data indicative of the person's head, hands, feet, elbows, shoulders, knew, etc into different array voxels. That is, it may not be necessary to completely recreate the person but, instead, it may be sufficient to incorporate data into the array indicative of key points on the person which allow for pose estimation to be performed.

In one or more embodiments, the method may comprise removing 1003 or adjusting data from one or more feature vectors associated with the presence of a first object 902 such that the first object 902 is removed from or adjusted within the 3D volume represented by the array. For example, the voxel score indicative of the presence of an object may be changed to a null value indicative that no object is present within the voxel of the 3D volume represented by the array voxel. Alternatively, the feature vector associated with the array voxel that comprises the first object may be changed such that the first object in the 3D volume represented by the array voxel is replaced with a second, different, object. In this way, for example, a person may be removed from the represented 3D volume and, optionally, replaced with a different object. In other examples, the changes to the array may make it appear that a surgeon is holding a scalpel instead of suture or suture instead of a syringe.

In yet other examples, the method may comprise moving 1004 data associated with an object within the 3D volume from a first feature vector to a second, different, feature vector. In this way, an object may be moved from a first location within the 3D volume to a second location.

The data indicative of a fictional object may be based, in one or more examples, on data indicative of a real object from one or more spatial representations used to generate the array. In other examples, the data indicative of a fictional object may be based on data indicative of a real object from one or more spatial representations used to generate a different array, such as an array of a different 3D volume or the same 3D volume at a different point in time.

It will be appreciated that any of the above operations of adding 1002, removing 1003, changing or moving 1004 objects within the representation of the 3D defined by the array may be performed one or a plurality of times. Further, any combination of the above operations may be performed. In the example of FIG. 9, it can be seen that two new people 901 have been added to the image by copying data associated with one of the original people and placing them in different locations within the 3D volume. Further, a person 902 sitting at the computer has been removed. By making these alterations to the array, it is possible to generate a whole new scene (3D volume) for analysis.

In order to robustly train the ML algorithm, it may be desirable to generate new 2D spatial representations based on the generated synthetic data. That is, the feature space defined by the array may be projected into a 2D spatial representation which can be incorporated into the plurality of spatial representations or into a new plurality of spatial representations. The 2D spatial representation may be generated by initially selecting a point of view from which the 2D spatial representation should originate. The point of view may be the point of view of a known spatial representation capture device, i.e., the position of a spatial representation capture device that has been used to capture a 2D spatial representation of the plurality of spatial representations used to generate the initial array. In other examples, any point of view, i.e., any position within or outside of the 3D volume, may be used as the point of view for generating the 2D spatial representation. The method further comprises projecting the feature vectors of the array into a 2D spatial representation based on the selected point of view. Projecting the 2D feature vectors of the array into the 2D spatial representation may comprise determining which objects represented in the array would be visible from the point view and projecting confidence values indicative of the presence of these objects onto a plurality of segments representative of the 2D spatial representation. The projected 2D spatial representation may be a segmented mathematical construct indicative of the presence of one or more objects within the 3D volume visible from the point of view as opposed to a true recreation of a photo, for example.

FIG. 11 shows an example method 1100 of training an ML algorithm comprising receiving 1101 the synthetic data generated according to the method described with reference to FIGS. 9 and 10 and training 1102 the ML algorithm using the generated synthetic data. It will be appreciated that there are many different ways in which to train an ML algorithm and so these will not be discussed in detail herein.

FIG. 12 shows an example computer program product 1200 comprising computer program code configured to, when executed on a processor, cause the processor to carry out any of the methods described herein.

It will be appreciated that the features and embodiments disclosed herein above may be combined together in any manner except for where to do so would be explicitly against the teachings of the present disclosure. By way of non-limiting example: the method of generating synthetic data may be performed based on an array generated using the method of identifying the location of one or more objects; the method of training an ML algorithm may be based on the synthetic data generated as described with reference to FIGS. 9 and 10; the method of identifying the position of an object may be performed after training the ML algorithm using the synthetic data in order to obtain more accurate classification results. Further examples that will be apparent to the skilled person include that positions of a plurality of different objects may be determined either once or multiple times using ROI iterations and, based on these object position detections, one or more object interrelations may be determined which may subsequently allow for efficient tracking of the objects as they move through space over time. Every possible combination or permutation of features has not been described for brevity and so as to avoid obfuscating the benefits of each of the features disclosed here. Further, while some features may be considered to be listed in seemingly separate embodiments, this does not imply that some features may not be advantageously synergistically combined in order to provide for a contribution which is greater than the sum of its parts.

1. A computer implemented method of determining the position of an object in a 3D volume comprising:
a) receiving a plurality of captured spatial representations wherein each spatial representation comprises a representation of contents of the 3D volume and wherein each spatial representation is captured from a position with a point of view of the 3D volume wherein each spatial representation is one of a 2D spatial representation and a 3D spatial representation;
b) for each 2D spatial representation, defining a plurality of segments of the 2D representation wherein each segment defines an area of the 2D representation;
c) for each 3D spatial representation, defining a plurality of representation voxels of the 3D spatial representation wherein each representation voxel defines a sub-volume of the 3D volume;
d) assigning a first prediction score to each segment of each 2D spatial representation and assigning a first prediction score to each representation voxel of each 3D spatial representation wherein each first prediction score is indicative of a confidence that the segment or representation voxel comprises a first object;
e) generating an array representative of the 3D volume wherein the array defines a plurality of array voxels wherein each array voxel is representative of a different sub-volume of the 3D volume;
f) associating each segment of each 2D spatial representation with a plurality of the array voxels within the array based on the point of view from which the respective 2D spatial representation was captured, wherein the array voxels associated with each segment are those which are representative of positions of the segment at potential depths through the 3D volume at which the contents in the 2D spatial representation may be positioned;
g) associating each representation voxel of each 3D spatial representation with at least one array voxel based on the point of view from which the respective 3D spatial representation was captured;
h) assigning a first voxel score to each array voxel wherein each first voxel score is based on the first prediction score associated with each segment associated with the respective array voxel and each first prediction score associated with each representation voxel associated with the respective array voxel; and
i) using a classification algorithm to classify an object within the 3D volume based on the first voxel scores.

2. The method of claim 1 further comprising the steps of:
i) determining a region of interest based on the first voxel scores, wherein the region of interest is a region of the 3D volume that is represented by one or more array voxels;
j) receiving a focussed plurality of spatial representations, wherein the focussed plurality of spatial representations comprises spatial representations that comprise the region of interest;
k) for each 2D spatial representation of the focussed plurality of spatial representations defining a plurality of ROI segments of the 2D representation wherein each ROI segment defines an area of the region of interest;
l) for each 3D spatial representation of the focussed plurality of spatial representations, defining a plurality of ROI representation voxels of the 3D spatial representation wherein each ROI representation voxel defines a sub-volume of the region of interest;
m) assigning a first focussed prediction score to each ROI segment of each 2D spatial representation of the focussed plurality of spatial representations and assigning a first focussed prediction score to each ROI representation voxel of each 3D spatial representation wherein the first focussed prediction score is indicative of a confidence that the ROI segment or ROI representation voxel comprises the first object;
n) generating an ROI array representative of the region of interest of the 3D volume wherein the ROI array comprises a plurality of ROI array voxels wherein each ROI array voxel is representative of a different sub-volume of the region of interest;
o) associating each ROI segment of each 2D spatial representation of the focussed plurality of spatial representations with a plurality of ROI voxels within the ROI array based on the point of view from which the respective 2D spatial representation was captured, wherein the ROI array voxels associated with each ROI segment are those which are representative of positions of the ROI segment at potential depths through the 3D volume at which the contents in the 2D spatial representation may be positioned;
p) associating each ROI representation voxel of each 3D spatial representation of the focussed plurality of spatial representations with at least one ROI array voxel based on the point of view from which the respective 3D spatial representation was captured;
q) assigning a first focussed voxel score to each ROI array voxel wherein each first focussed voxel score is based on the first focussed prediction score associated with each ROI segment associated with the respective ROI array voxel and each first focussed prediction score associated with each ROI representation voxel associated with the respective ROI array voxel; and
r) wherein step i) of using a classification algorithm to classify an object within the 3D volume is further based on the first focussed voxel scores.

3. The method of claim 1 wherein the first voxel score is a feature vector.

4. The method of claim 2 wherein the first focussed voxel score is a feature vector.

5. The method of claim 1 wherein the method further comprises:
assigning a second prediction score to each segment of each 2D spatial representation and assigning a second prediction score to each representation voxel of each 3D spatial representation wherein each second prediction score is indicative of a confidence that the segment or representation voxel comprises a second object;
assigning a second voxel score to each array voxel wherein each second voxel score is based on the second prediction score associated with each segment associated with the respective array voxel and each second prediction score associated with each representation voxel associated with the respective array voxel; and
using the classification algorithm to classify a second object within the 3D volume based on the second voxel scores.

6. The method of claim 5 wherein each feature vector comprises one or both of:
a plurality of voxel scores comprising at least the first voxel score and the second voxel score wherein each voxel score is indicative of an aggregate confidence value of a classification of the presence of an object being present within the segments and representation voxels associated with the array voxel with which the feature vector is associated; and
a plurality of focussed voxel scores comprising at least the first focussed voxel score and a second focussed voxel score, wherein each focussed voxel score is indicative of an aggregate confidence value of a classification of the presence of an object being present within the ROI segments and ROI representation voxels associated with the ROI array voxel with which the feature vector is associated.

7. The method of claim 6 wherein the method further comprises using a classification algorithm to classify a second object within the 3D volume based on one or more feature vectors of the array voxels or the ROI array voxels.

8. The method of claim 7 further comprising the steps of:
determining, by way of predetermined interrelation information, whether the first object is interrelated with the second object and, if the first object is interrelated with the second object, recording the interrelation between the first object and the second object.

9. The method of claim 8 wherein determining whether the first object is associated with the second object is based on a comparison of the interrelation information with one or both of:
a distance between the first object and the second object;
an angle between the first object and the second object
an overlap between a 3D bounding box of the first object and a 3D bounding box of the second object;
an overlap between a 2D bounding box of the first object and a 2D bounding box of the second object;
a difference between received velocity information about the first object and received velocity information about the second object;
a difference between received acceleration information about the first object and received velocity information about the second object; and
the classification of the first object and the classification of the second object.

10. The method of claim 1 wherein, for each spatial representation of the plurality of spatial representations, the method further comprises receiving a plurality of additional spatial representations captured from the same points of view as their corresponding initial spatial representations at different points in time and wherein the method further comprises tracking the changes in position of the first object based on the determination of the position of the first object within the 3D volume.

11. The method of claim 10 wherein the interrelation between the first object and the second is determined to be a physical interrelation such that movement of the first object and the second object are spatially linked such that the second object can only move relative to the first object under predetermined constraints.

12. The method of claim 11 wherein tracking the position of the first and second objects in each of the additional spatial representations is further based on the predetermined constraints.

13. The method of claim 11 wherein the predetermined constraints define one or more of:
a fixed distance between the first object and the second object; and
a fixed range of rotational movement of the second object about the first object.

14. The method of claim 1 wherein at least two of the plurality of spatial representations are captured by different spatial representation capture devices.

15. (canceled)

16. The method of claim 3 further comprising:
receiving data indicative a fictional object; and
associating the fictional object with an array voxel by updating the feature vector of the voxel to incorporate the data indicative of the fictional object.

17. (canceled)

18. A computer implemented method of generating synthetic data representative of a 3D volume comprising:
receiving an array representative of the 3D volume wherein the array defines a plurality of array voxels wherein each array voxel is representative of a different sub-volume of the 3D volume and wherein each array voxel is associated with a feature vector indicative of the presence of one or more objects within the sub-volume represented by the array voxel; and one or more of:
receiving data indicative of a fictional object and associating the fictional object with an array voxel by updating the feature vector of the voxel to incorporate the data indicative of the fictional object;
removing or adjusting data from one or more feature vectors associated with the presence of the first object such that the first object is removed from or adjusted within the 3D volume represented by the array; and
moving data associated with an object within the 3D volume from a first feature vector to a second feature vector wherein the second feature vector is different to the first feature vector.

19. The method of claim 18 wherein received data indicative of a fictional object is based on data indicative of a real object within the array.

20. The method of claim 18 further comprising generating a 2D spatial representation based on the generated synthetic data by:
selecting a point of view from which the 2D spatial representation should originate; and
projecting the feature vectors of the array into a 2D spatial representation based on the selected point of view.

21. A computer implemented method of training an ML algorithm comprising:
receiving synthetic data generated according to the method of claim 18; and
training the ML algorithm using the generated synthetic data.

22. A computer program product comprising computer program code configured such that, when executed on a processor, the computer program code is configured to cause a processor to carry out a computer implemented method according to claim 1.
